(19) United States
(12) Patent Application Publication
(10) Pub. No.: US 2026/0034454 A1
(43) Pub. Date: Feb. 5, 2026

(54) VEHICLE ENTRY CONTROL

(71) Applicant: TENCENT TECHNOLOGY (SHENZHEN) COMPANY LIMITED, Shenzhen (CN)

(72) Inventors: Qingbo YU, Shenzhen (CN); Wei MO, Shenzhen (CN); Ya ZHANG, Shenzhen (CN)

(73) Assignee: TENCENT TECHNOLOGY (SHENZHEN) COMPANY LIMITED, Shenzhen (CN)

(21) Appl. No.: 19/357,921

(22) Filed: Oct. 14, 2025

Related U.S. Application Data
(63) Continuation of application No. PCT/CN2024/134140, filed on Nov. 25, 2024.

(30) Foreign Application Priority Data
Jan. 2, 2024 (CN) 202410008103.6

(51) Int. Cl. A63F 13/57; A63F 13/52; A63F 13/533; A63F 13/803

(52) U.S. Cl. CPC A63F 13/57; A63F 13/52; A63F 13/533; A63F 13/803

(57) ABSTRACT

In a method for controlling a virtual object, at least one virtual vehicle and a vehicle entry control element are output for display in a virtual scene. A first virtual vehicle of the at least one virtual vehicle that is associated with the vehicle entry control element is obtained. A first indication of which of the at least one virtual vehicle is the first virtual vehicle that is associated with the vehicle entry control element is output for display. A trigger operation performed on the vehicle entry control element is received. Based on the trigger operation performed on the vehicle entry control element when the vehicle entry control element is associated with the first virtual vehicle, the virtual object is controlled to automatically enter the first virtual vehicle associated with the vehicle entry control element.

### RELATED APPLICATIONS

The present application is a continuation of International Application No. PCT/CN2024/134140, filed on Nov. 25, 2024, which claims priority to Chinese Patent Application No. 202410008103.6, filed on Jan. 2, 2024. The entire disclosures of the prior applications are hereby incorporated by reference.

### FIELD OF THE TECHNOLOGY

This application relates to the field of Internet technologies, including a method for controlling a virtual object.

### BACKGROUND OF THE DISCLOSURE

In a related game, when a player needs to enter a vehicle, a virtual object controlled by the player needs to be manually moved beside a corresponding vehicle, and then enters the vehicle. In addition, if a distance between the vehicle and another vehicle is excessively small, when the player moves beside the vehicle, the vehicle which the player intends to enter may not be accurately selected, that is, the player may randomly enter one of the vehicles. Based on this, in related technology, efficiency and accuracy of the virtual object entering the vehicle are both low, and human-computer interaction efficiency and utilization of hardware processing resources are also low.

### SUMMARY

Aspects of this disclosure provide a method for controlling a virtual object, an apparatus for controlling a virtual object, and a non-transitory computer-readable storage medium, which can improve efficiency and accuracy of a virtual object entering a vehicle and human-computer interaction efficiency and utilization of hardware processing resources. Examples of technical solutions of this disclosure may be implemented as follows:

An aspect of this disclosure provides a method for controlling a virtual object. In the method, at least one virtual vehicle and a vehicle entry control element are output for display in a virtual scene. A first virtual vehicle of the at least one virtual vehicle that is associated with the vehicle entry control element is obtained. A first indication of which of the at least one virtual vehicle is the first virtual vehicle that is associated with the vehicle entry control element is output for display. A trigger operation performed on the vehicle entry control element is received. Based on the trigger operation performed on the vehicle entry control element when the vehicle entry control element is associated with the first virtual vehicle, the virtual object is controlled to automatically enter the first virtual vehicle associated with the vehicle entry control element.

An aspect of this disclosure provides an information processing apparatus. The apparatus includes processing circuitry configured to output for display at least one virtual vehicle and a vehicle entry control element in a virtual scene. The processing circuitry is configured to obtain a first virtual vehicle of the at least one virtual vehicle that is associated with the vehicle entry control element. The processing circuitry is configured to output for display a first indication of which of the at least one virtual vehicle is the first virtual vehicle that is associated with the vehicle entry control element. The processing circuitry is configured to receive a trigger operation performed on the vehicle entry control element. Based on the trigger operation performed on the vehicle entry control element when the vehicle entry control element is associated with the first virtual vehicle, the processing circuitry is configured to control a virtual object to automatically enter the first virtual vehicle associated with the vehicle entry control element.

An aspect of this disclosure provides a method for controlling a virtual object, including: displaying at least one virtual vehicle and a vehicle control in a virtual scenario, a connecting element existing between the vehicle control and a first virtual vehicle in the at least one virtual vehicle, and the connecting element being configured for indicating a virtual vehicle associated with the vehicle control; and controlling, in response to a trigger operation on the vehicle control, a virtual object to automatically enter the first virtual vehicle associated with the vehicle control.

An aspect of this disclosure further provides an apparatus for controlling a virtual object, including: a display module, configured to display at least one virtual vehicle and a vehicle control in a virtual scenario, a connecting element existing between the vehicle control and a first virtual vehicle in the at least one virtual vehicle, and the connecting element being configured for indicating a virtual vehicle associated with the vehicle control; and a control module, configured to control, in response to a trigger operation on the vehicle control, a virtual object to automatically enter the first virtual vehicle associated with the vehicle control.

An aspect of this disclosure provides an electronic device, including: a memory, configured to store computer-executable instructions or a computer program; and a processor, configured to implement, when executing the computer-executable instructions or the computer program stored in the memory, the method for controlling a virtual object provided in the aspects of this disclosure.

An aspect of this disclosure provides a non-transitory computer-readable storage medium storing instructions which, when executed by a processor, cause the processor to implement the method for controlling a virtual object provided in the aspects of this disclosure.

An aspect of this disclosure provides a computer program product, the computer program product includes computer-executable instructions or a computer program, and the computer-executable instructions or the computer program are stored in a computer-readable storage medium. A processor of an electronic device reads the computer-executable instructions or the computer program from the computer-readable storage medium, and executes the computer-executable instructions or the computer program, to cause the electronic device to implement the method for controlling a virtual object provided in the aspects of this disclosure.

The aspects of this disclosure include the following beneficial effects:

When a virtual vehicle is displayed in a virtual scenario, a vehicle control and a connecting element configured for indicating an association relationship between the vehicle control and a first virtual vehicle are further displayed, to control, based on the connecting element and in response to a trigger operation on the vehicle control, a virtual object to automatically enter the first virtual vehicle associated with the vehicle control. In this way, compared with a solution in which the virtual object needs to be manually moved beside a corresponding vehicle and then enters the vehicle, a solution in which when a trigger operation performed by a user on the vehicle control is received, the virtual object is controlled to automatically enter the first virtual vehicle associated with the vehicle control improves efficiency of the virtual object entering the vehicle. In addition, based on the connecting element configured for indicating the association relationship between the vehicle control and the first virtual vehicle, a virtual vehicle that can be entered based on the vehicle control is clarified, that is, a virtual vehicle to be entered by the virtual object is clarified. This not only improves accuracy of the virtual object entering the vehicle, further improving efficiency of the virtual object entering the vehicle, but also improves human-computer interaction efficiency and utilization of hardware resources of an electronic device.

### BRIEF DESCRIPTION OF THE DRAWINGS

FIG. 1 is a schematic diagram of an architecture of a system for controlling a virtual object according to an aspect of this disclosure.

FIG. 2 is a schematic diagram of a structure of an electronic device according to an aspect of this disclosure.

FIG. 3 is a schematic flowchart of a method for controlling a virtual object according to an aspect of this disclosure.

FIG. 4 is a schematic diagram of a connecting element according to an aspect of this disclosure.

FIG. 5 is a schematic diagram of a process of switching a vehicle based on a vehicle control according to an aspect of this disclosure.

FIG. 6 is a schematic diagram of a process of switching a vehicle control from a fixed state to a draggable state according to an aspect of this disclosure.

FIG. 7 is a schematic diagram of displaying attribute information of a first virtual vehicle according to an aspect of this disclosure.

FIG. 8 is a schematic diagram of a process of controlling a virtual object to enter a first virtual vehicle associated with a vehicle control according to an aspect of this disclosure.

FIG. 9 is a schematic diagram of a distance progress bar according to an aspect of this disclosure.

FIG. 10 is a schematic diagram of a countdown according to an aspect of this disclosure.

FIG. 11 is a schematic flowchart of an operation solution for accurate selection of boarding a vehicle when a plurality of vehicles are provided according to an aspect of this disclosure.

### DETAILED DESCRIPTION

To make objectives, technical solutions, and advantages of this disclosure clearer, the following describes aspects of this disclosure in further detail with reference to the accompanying drawings. The described aspects are not to be considered as a limitation to the aspects of this disclosure. Other aspects shall fall within the scope of this disclosure. Further, the descriptions of the terms are provided as examples only and are not intended to limit the scope of the disclosure.

In the following descriptions, “some aspects” describe a subset of all possible aspects. However, the “some aspects” may be the same subset or different subsets of all the possible aspects, and may be combined with each other without conflict.

In the following descriptions, “first/second/third” is merely intended to distinguish similar objects but does not necessarily indicate a specific order of an object. “First/second/third” is interchangeable in terms of a specific order or sequence if permitted, so that the aspects of this disclosure described herein can be implemented in a sequence in addition to the sequence shown or described herein.

Unless otherwise defined, meanings of all technical and scientific terms used in this specification are the same as those usually understood by a person skilled in the art to which this disclosure belongs. Examples of terms used in this specification are merely intended to describe the objectives of the aspects of this disclosure, but are not intended to limit this disclosure.

Before the aspects of this disclosure are further described in detail, examples of nouns and terms involved in the aspects of this disclosure are described. The examples of the nouns and the terms provided in the aspects of this disclosure are applicable to the following explanations.

(1) Client: It is also referred to as a user terminal, and refers to a program that corresponds to a server and that provides a local service for a user. Except some application programs that can only be run locally, the client is usually installed on a common client, and needs to run in coordination with the server, that is, a corresponding server and a corresponding service program in a network are needed to provide a corresponding service. In this way, a specific communication connection needs to be established between the client and the server, to ensure normal running of an application program, for example, an autonomous driving client (such as a map navigation client).

(2) Artificial intelligence (AI): It is a theory, a method, a technology, and an application system that uses a digital computer or a machine controlled by the digital computer to simulate, extend, and expand human intelligence, perceive an environment, acquire knowledge, and use knowledge to obtain an optimal result. In other words, the artificial intelligence is a comprehensive technology in computer science and aims to understand the essence of intelligence and produce a new intelligent machine that can react in a manner similar to human intelligence. The artificial intelligence is to study design principles and implementation methods of various intelligent machines, to enable the machines to have functions of perception, reasoning, and decision-making.

(3) Virtual scenario: It is a virtual scenario displayed (or provided) by an application program when run on a terminal. The virtual scenario may be a simulated environment of a real world, or may be a semi-simulated semi-fictional virtual environment, or may be an entirely fictional virtual environment. The virtual scenario may be any one of a two-dimensional virtual scenario, a 2.5-dimensional virtual scenario, or a three-dimensional virtual scenario.

For example, the virtual scenario may include the sky, the land, the ocean, or the like. The land may include environmental elements such as a desert and a city. A user may control a virtual object to move in the virtual scenario. The movement includes, and is not limited to, at least one of adjusting a body posture, crawling, walking, running, riding, jumping, driving, picking up, shooting, attacking, or throwing. The virtual scenario may be displayed at a first-person perspective (for example, playing a virtual object in a game at a perspective of the user himself/herself), or the virtual scenario may be displayed at a third-person perspective (for example, the user follows a virtual object in a game to play the game), or the virtual scenario may be displayed at a bird's eye perspective, and the foregoing perspectives may be randomly switched.

(4) In response to: It is configured for indicating a condition or a status on which a to-be-performed operation depends. When the condition or the status is met, one or more to-be-performed operations may be real-time or have a set delay. Unless otherwise specified, there is no chronological order between the plurality of to-be-performed operations.

(5) Virtual object: It is an image of various persons and objects that can interact with each other in a virtual scenario, or a movable object in a virtual scenario. The movable object may be a virtual character, a virtual animal, a cartoon character, or the like, for example, a character, an animal, a plant, an oil drum, a wall, a stone, or a vehicle displayed in the virtual scenario. The virtual object may be a virtual image configured for representing a user in the virtual scenario. The virtual scenario may include a plurality of virtual objects, and each virtual object has a shape and a volume in the virtual scenario, and occupies some space in the virtual scenario.

For example, the virtual object may be a player character controlled through an operation on a client, or may be an artificial intelligence (AI) character set in a virtual scenario battle through training, or may be a non-player character (NPC) set in virtual scenario interaction. A quantity of virtual objects participating in the interaction in the virtual scenario may be preset, or may be dynamically determined according to a quantity of clients participating in the interaction.

(6) Third-person perspective: It is a perspective in which a camera is at a position behind a player character by a particular distance in a game, and the character and all combat elements in a surrounding environment can be seen in a picture.

(7) First-person perspective: It is a perspective in which a camera is at an eye position of a player character in a game, and a body part of the character and all combat elements in a surrounding environment can be seen in a picture.

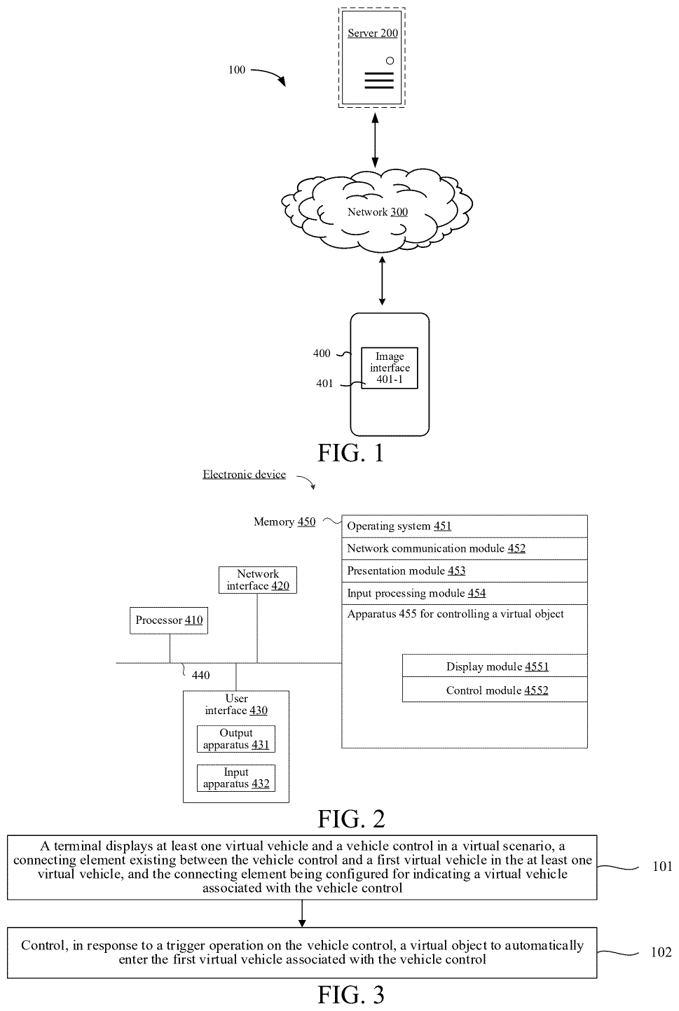

FIG. 1 is a schematic diagram of an architecture of a system for controlling a virtual object according to an aspect of this disclosure. A control client 401 of a virtual object is disposed on a terminal (a terminal 400 is shown as an example), and is displayed on a display interface (an image interface 401-1 is shown as an example). The terminal 400 is connected to a server 200 through a network 300. The network 300 may be a wide area network, a local area network, or a combination thereof, and data transmission is implemented by using a wireless or wired link.

The server 200 is configured to transmit scenario data that corresponds to a virtual scenario including at least one virtual vehicle and a vehicle control to the terminal 400; and
the terminal 400 is further configured to receive the scenario data that corresponds to the virtual scenario including the at least one virtual vehicle and the vehicle control and that is transmitted by the server 200, and display the virtual scenario based on the scenario data; display the at least one virtual vehicle and the vehicle control in the virtual scenario, a connecting element existing between the vehicle control and a first virtual vehicle in the at least one virtual vehicle, and the connecting element being configured for indicating a virtual vehicle associated with the vehicle control; and control, in response to a trigger operation on the vehicle control, the virtual object to automatically enter the first virtual vehicle associated with the vehicle control.

In some aspects, the server 200 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. The terminal 400 may be a smart phone, a tablet computer, a notebook computer, a desktop computer, a set-top box, an intelligent voice interaction device, a smart home appliance, a virtual reality device, a vehicle-mounted terminal, an aircraft, a portable music player, a personal digital assistant, a dedicated messaging device, a portable gaming device, a smart speaker, a smart watch, or the like, and is not limited to this. The terminal and the server may be directly or indirectly connected in a wired or wireless communication manner. This is not limited in the aspects of this disclosure.

An electronic device implementing a method for controlling a virtual object provided in the aspects of this disclosure is described below. FIG. 2 is a schematic diagram of a structure of an electronic device according to an aspect of this disclosure. The electronic device may be a server or a terminal. Using an example in which the electronic device is the terminal shown in FIG. 1, the electronic device shown in FIG. 2 includes at least one processor 410 (an example of processing circuitry), a memory 450 (an example of a non-transitory computer-readable storage medium), at least one network interface 420, and a user interface 430. All the components in the terminal 400 are coupled together through a bus system 440. The bus system 440 is configured to implement connection and communication between these components. In addition to a data bus, the bus system 440 further includes a power bus, a control bus, and a state signal bus. However, for ease of clear description, all types of buses are marked as the bus system 440 in FIG. 3.

The processor 410 may be an integrated circuit chip having a signal processing capability, for example, a general purpose processor, a digital signal processor (DSP), or another programmable logic device, discrete gate, transistor logical device, or discrete hardware component. The general purpose processor may be a microprocessor, any conventional processor, or the like.

The user interface 430 includes one or more output apparatuses 431 that can display media content, including one or more speakers and/or one or more visual display screens. The user interface 430 further includes one or more input apparatuses 432, including user interface components that facilitate inputting of a user, such as a keyboard, a mouse, a microphone, a touch display screen, a camera, and other input buttons and controls.

The memory 450 may be a removable memory, a non-removable memory, or a combination thereof. Examples of hardware devices include a solid-state memory, a hard disk drive, an optical disc driver, and the like. In some aspects, the memory 450 includes one or more storage devices away from the processor 410 in a physical position.

The memory 450 includes a volatile memory or a non-volatile memory, or may include both a volatile memory and a non-volatile memory. The non-volatile memory may be a read only memory (ROM). The volatile memory may be a random access memory (RAM). The memory 450 described in this aspect of this disclosure is to include any suitable type of memory.

In some aspects, the memory 450 may store data to support various operations. Examples of the data include a program, a module, and a data structure, or a subset or a superset thereof, which are described below by using examples.

An operating system 451 includes a system program configured to process various basic system services and perform a hardware-related task, for example, a framework layer, a core library layer, and a driver layer, and is configured to implement various basic services and process a hardware-based task.

A network communication module 452 is configured to reach another electronic device through one or more (wired or wireless) network interfaces 420. Examples of network interfaces 420 include Bluetooth, Wi-Fi, a universal serial bus (USB), and the like.

A presentation module 453 is configured to display information by using the output apparatus 431 (for example, a display screen or a speaker) associated with one or more user interfaces 430 (for example, a user interface configured to operate a peripheral device and display content and information).

An input processing module 454 is configured to detect an input or interaction of the user from one of the input apparatuses 432 and translate the detected input or interaction.

In some aspects, the apparatus provided in the aspects of this disclosure may be implemented by using software. FIG. 2 shows an apparatus 455 for controlling a virtual object stored in the memory 450. The apparatus 455 for controlling a virtual object may be software in a form such as a program and a plug-in, and includes the following software modules: a display module 4551 and a control module 4552. These modules are logical modules, and therefore, these modules may be randomly combined or further divided based on a function to be performed. The following describes functions of the modules.

In some other aspects, the apparatus provided in the aspects of this disclosure may be implemented by using hardware. For example, the apparatus for controlling a virtual object provided in the aspects of this disclosure may be a processor in a form of a hardware decoding processor, and is programmed to perform the method for controlling a virtual object provided in the aspects of this disclosure. For example, the processor in the form of a hardware decoding processor may use one or more application specific integrated circuits (ASICs), a DSP, a programmable logic device (PLD), a complex programmable logic device (CPLD), a field-programmable gate array (FPGA), or other electronic components.

In some aspects, the terminal or the server may implement the method for controlling a virtual object provided in the aspects of this disclosure by running a computer program. For example, the computer program may be a native program or a software module in an operating system; may be a native application (APP), that is, a program that needs to be installed in an operating system before being run, such as an instant messaging APP or a web browser APP; may be a mini program, that is, a program that can be run only when being downloaded into a browser environment; or may be a mini program that can be embedded in any APP. In conclusion, the foregoing computer program may be any form of an application program, a module, or a plug-in.

Based on the foregoing descriptions of the system for controlling a virtual object and the electronic device provided in the aspects of this disclosure, the method for controlling a virtual object provided in the aspects of this disclosure is described below. During actual implementation, the method for controlling a virtual object provided in the aspects of this disclosure may be independently implemented by the terminal or the server, or may be cooperatively implemented by the terminal and the server. An example in which the terminal 400 in FIG. 1 independently executes the method for controlling a virtual object provided in the aspects of this disclosure is used for description. FIG. 3 is a schematic flowchart of a method for controlling a virtual object according to an aspect of this disclosure, which is described in combination with operations shown in FIG. 3.

Operation 101: Display at least one virtual vehicle and a vehicle control in a virtual scenario, a connecting element existing between the vehicle control and a first virtual vehicle in the at least one virtual vehicle, and the connecting element being configured for indicating a virtual vehicle associated with the vehicle control. For example, at least one virtual vehicle and a vehicle entry control element are output for display in a virtual scene. A first virtual vehicle of the at least one virtual vehicle that is associated with the vehicle entry control element is obtained. A first indication of which of the at least one virtual vehicle is the first virtual vehicle that is associated with the vehicle entry control element is output for display. In another example, the first indication of which of the at least one virtual vehicle is the first virtual vehicle includes display of a connecting element that is configured to indicate the first virtual vehicle.

During actual implementation, an application program supporting the virtual scenario is installed and run on the terminal. The application program may be any of a first-person shooting game, a third-person shooting game, a multi-player online tactical competitive game, a virtual reality application program, a three-dimensional map program, or a multi-player gunfight survival game.

When a user opens the application program on the terminal, and the terminal runs the application program, the terminal presents a picture of the virtual scenario. The picture of the virtual scenario is obtained by observing the virtual scenario from a first-person object perspective, or by observing the virtual scenario from a third-person perspective. The picture of the virtual scenario includes the at least one virtual vehicle and the vehicle control, and the virtual vehicle may assist a player character in moving in the virtual scenario. Common virtual vehicles include a virtual car, a virtual ship, a virtual plane, and the like. The virtual scenario may further include a virtual object, the virtual object may be a player character controlled by a user account that currently logs in to the application program, and the user may operate the virtual object in the virtual scenario by using the terminal to perform activities. For example, the virtual object may be a player character controlled by a user entering a driving game or a simulated virtual scenario, or may be a virtual vehicle carrying the player character controlled by the user account that currently logs in to the application program. In addition, the virtual scenario may further include another virtual object or interaction object, which may be controlled by another user or controlled by a robot. This is not limited in the aspects of this disclosure.

A form, such as a connecting line or a connecting special effect, of the connecting element may be preset. For example, FIG. 4 is a schematic diagram of a connecting element according to an aspect of this disclosure. Based on FIG. 4, the connecting element may be in the form of the connecting line, 401 indicates the vehicle control, and 402 indicates the connecting element in the form of the connecting line.

The connecting element and the vehicle control may be simultaneously displayed. When the virtual object is far away from the virtual vehicle, the vehicle control and the connecting element are not displayed, and when the virtual object approaches the virtual vehicle, the vehicle control and the connecting element are displayed. When the at least one virtual vehicle and the vehicle control are displayed in the virtual scenario, the virtual object may further be displayed in the virtual scenario simultaneously, the virtual object is located outside the at least one virtual vehicle, and the at least one virtual vehicle may be in a static state or a moving state. The virtual object is located outside a sensing range of the at least one virtual vehicle, and the virtual object is controlled, in response to a movement instruction for the virtual object, to move to the at least one virtual vehicle, so that a process of displaying the virtual vehicle in the virtual scenario may be displaying the vehicle control when the virtual object moves into the sensing range of the at least one virtual vehicle.

A distance between each virtual vehicle in the at least one virtual vehicle is less than a first distance threshold, and the first distance threshold is preset. In addition, a process of determining whether the virtual object is located inside the sensing range of the at least one virtual vehicle may be obtaining a distance between each virtual vehicle and the virtual object, selecting a smallest distance from distances, comparing the smallest distance with a second distance threshold, and determining, when the smallest distance is less than or equal to the second distance threshold, that the virtual object is located inside the sensing range of the at least one virtual vehicle, or determining, when the smallest distance is greater than the second distance threshold, that the virtual object is located outside the sensing range of the at least one virtual vehicle.

By applying the foregoing aspect, the virtual object moves to the virtual vehicle only when the virtual object intends to enter the virtual vehicle, so that the vehicle control is displayed only when the virtual object moves into the sensing range of the virtual vehicle. In this way, a case that the vehicle control is displayed when the user does not intend to enter the virtual vehicle is avoided, which not only reduces waste of display resources, but also improves user experience.

During actual implementation, when the virtual object moves into the sensing range of the at least one virtual vehicle, the vehicle control is displayed, and the first virtual vehicle in the at least one virtual vehicle is determined, to connect the first virtual vehicle and the vehicle control by using the connecting element, that is, the connecting element is displayed between the first virtual vehicle and the vehicle control.

There are a plurality of processes of determining the first virtual vehicle in the at least one virtual vehicle. For example, the first virtual vehicle in the at least one virtual vehicle may be determined based on the distance between each virtual vehicle and the virtual object, may be determined based on an attribute parameter of each virtual vehicle such as a performance level, a maximum movement speed, a rarity, or control difficulty, may be determined based on selection by the user, or may be determined based on historical behavior data of the user such as a common virtual vehicle. Next, the processes of determining the first virtual vehicle in the at least one virtual vehicle are separately described.

In some aspects, the first virtual vehicle is determined according to the distance to the virtual object. Before the virtual object is controlled, in response to a trigger operation on the vehicle control, to automatically enter the first virtual vehicle associated with the vehicle control, a second virtual vehicle in the at least one virtual vehicle may further be determined as the first virtual vehicle in response to a distance between the virtual object and the second virtual vehicle meeting a distance condition, and the connecting element is controlled to connect the vehicle control and the second virtual vehicle.

The distance condition may be preset, for example, may be a smallest distance. That a distance between the virtual object and the second virtual vehicle in the at least one virtual vehicle meets the distance condition refers to that the distance between the virtual object and the second virtual vehicle is the smallest distance, that is, the second virtual vehicle in the at least one virtual vehicle is closest to the virtual object. In this case, the virtual object is located outside the at least one virtual vehicle.

During actual implementation, before responding to a distance between the virtual object and the first virtual vehicle in the at least one virtual vehicle meeting the distance condition, the virtual object is controlled, in response to a control operation on the virtual object, to move around the at least one virtual vehicle. In a movement process of the virtual object, the distance between each virtual vehicle and the virtual object is obtained in real time, and when the distance between the virtual object and the second virtual vehicle in the at least one virtual vehicle meets the distance condition, that is, it is determined, based on each distance, that the second virtual vehicle is closest to the virtual object, the second virtual vehicle is determined as the first virtual vehicle, and the connecting element is controlled to connect the vehicle control and the second virtual vehicle.

In an actual application, the vehicle control and the corresponding virtual vehicle are connected by using the connecting element only when the distance between the virtual vehicle and the virtual object meets the distance condition, for example, the virtual vehicle is closest to the virtual object. In this way, this makes it easier for the virtual object to subsequently enter the corresponding virtual vehicle based on the vehicle control, thereby improving virtual vehicle entry efficiency and human-computer interaction efficiency.

During actual implementation, when there are at least two virtual vehicles, the first virtual vehicle connected to the connecting element may further be switched. There are a plurality of processes of switching the first virtual vehicle. Next, the process of switching the first virtual vehicle is described based on different manners.

In some aspects, a process of switching the first virtual vehicle may be controlling, in response to a movement instruction for the virtual object, the virtual object to move; and determining, in a movement process of the virtual object, in response to a virtual vehicle in the at least two virtual vehicles that meets the distance condition being switched from the second virtual vehicle to a third virtual vehicle, the third virtual vehicle as the first virtual vehicle, and switching the connecting element from connecting the vehicle control and the second virtual vehicle to connecting the vehicle control and the third virtual vehicle.

As described above, the distance condition may be preset, for example, may be the smallest distance. In the movement process of the virtual object, the distance between each virtual vehicle and the virtual object is obtained in real time, and the smallest distance is determined from at least two distances. When a virtual vehicle corresponding to the smallest distance changes from the second virtual vehicle to the third virtual vehicle, a virtual vehicle in the at least two virtual vehicles that meets the distance condition is determined to be switched from the second virtual vehicle to the third virtual vehicle, so that the third virtual vehicle is determined as the first virtual vehicle, and the connecting element is switched from connecting the vehicle control and the second virtual vehicle to connecting the vehicle control and the third virtual vehicle.

By applying the foregoing aspect, the virtual object is moved, so that the virtual vehicle connected to the connecting element may be switched. In other words, the virtual object is moved, so that a virtual vehicle to be automatically entered may be selected. In this way, this not only gives a vehicle selection right to the user, improving immersion and game experience of the user, but also improves human-computer interaction efficiency and utilization of hardware resources of the electronic device.

In some other aspects, the process of switching the first virtual vehicle may be switching, in response to a vehicle switching instruction triggered based on the vehicle control, the first virtual vehicle from the second virtual vehicle to a fourth virtual vehicle instructed by the vehicle switching instruction, and switching the connecting element from connecting the vehicle control and the second virtual vehicle to connecting the vehicle control and the fourth virtual vehicle.

In an actual application, the virtual vehicle to be automatically entered by the virtual object is switched through the vehicle switching instruction. In this way, the user is given the vehicle selection right, thereby not only improving human-computer interaction efficiency and utilization of hardware resources of the electronic device, but also improving game experience of the user.

The vehicle switching instruction is triggered by the vehicle control in a draggable state, and the draggable state may be a floating state. In this case, the vehicle switching instruction may be triggered by a dragging operation on the vehicle control in the draggable state, to display a draggable region corresponding to the vehicle control in the draggable state; and in response to a dragging operation that is performed on the vehicle control and that is performed in the draggable region, when a dragging angle of the dragging operation reaches a dragging angle threshold, the vehicle switching instruction triggered based on the vehicle control is received.

During actual implementation, the draggable region may be a circular region, and the vehicle control is dragged in the draggable region. In a process of dragging the vehicle control, an angle between a connecting line between a current position of the vehicle control and a position of the vehicle control before the vehicle control is dragged and a vertical line passing through a center of the draggable region, that is, the dragging angle, is obtained, to compare the dragging angle with the dragging angle threshold. When the dragging angle reaches the dragging angle threshold, the vehicle switching instruction triggered based on the vehicle control is received.

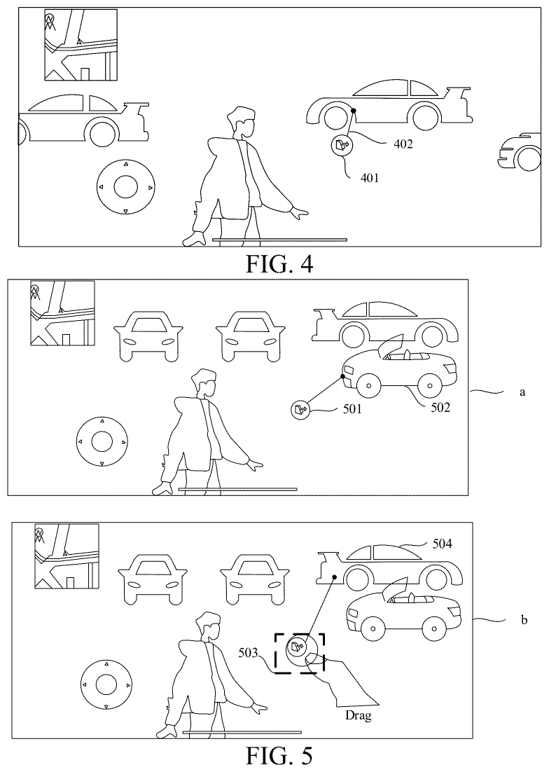

For example, FIG. 5 is a schematic diagram of a process of switching a vehicle based on a vehicle control according to an aspect of this disclosure. Based on FIG. 5, as shown in a of FIG. 5, a connecting element connects a vehicle control indicated by 501 and a second virtual vehicle indicated by 502, and then a draggable region corresponding to the vehicle control in the draggable state indicated by a dashed box 503 in b of FIG. 5 is displayed. In response to the dragging operation on the vehicle control in the draggable region, when the dragging angle of the dragging operation reaches the dragging angle threshold, a vehicle switching instruction that is triggered based on the vehicle control and that instructs to switch the first virtual vehicle from the second virtual vehicle to the fourth virtual vehicle indicated by 504 indicated by the vehicle switching instruction is received.

By applying the foregoing aspect, the vehicle switching instruction only occurs when the dragging angle of the dragging operation reaches the dragging angle threshold. In this way, a case of an accidental touch by the user is avoided, and accuracy of triggering the vehicle switching instruction is improved.

During actual implementation, when there are at least two virtual vehicles for switching, after the vehicle switching instruction triggered based on the vehicle control is received, a to-be-switched virtual vehicle instructed by the vehicle switching instruction further needs to be determined, and the vehicle switching instruction needs to be analyzed, the vehicle switching instruction carrying the dragging angle of the dragging operation and being configured for indicating a corresponding virtual vehicle needing to be switched to. In addition, when there are at least two virtual vehicles for switching, there are also at least two dragging angle thresholds. When the dragging angle reaches the dragging angle threshold, the vehicle switching instruction triggered based on the vehicle control is received, that is, when the dragging angle reaches a minimum dragging angle threshold, the vehicle switching instruction triggered based on the vehicle control is received.

When there are at least two virtual vehicles for switching, there are also at least two dragging angle thresholds. When the connecting line between the current position of the vehicle control and the position before the vehicle control is dragged is to the left of the vertical line passing through the center of the draggable region, the dragging angle is negative. When the connecting line between the current position of the vehicle control and the position before the vehicle control is dragged is to the right of the vertical line passing through the center of the draggable region, the dragging angle is positive. Therefore, the at least two dragging angle thresholds also include positive and negative. The at least two dragging angle thresholds form at least two dragging angle threshold intervals, and each virtual vehicle for switching has a corresponding dragging angle threshold interval. After the dragging angle corresponding to the dragging operation is determined based on the vehicle switching instruction, the dragging angle threshold interval to which the dragging angle corresponding to the dragging operation belongs is determined, and then the virtual vehicle for switching that corresponds to the corresponding dragging angle threshold interval is obtained, so that the corresponding virtual vehicle is switched to. The vehicle switching instruction instructs to switch to the corresponding virtual vehicle.

During actual implementation, the vehicle control is initially in a fixed state, and is configured to subsequently control, in response to the trigger operation on the vehicle control, the virtual object to automatically enter the first virtual vehicle associated with the vehicle control. In the foregoing process, the vehicle control is in the draggable state. Based on this, before the draggable region corresponding to the vehicle control in the draggable state is displayed, a state of the vehicle control further needs to be switched. Before the draggable region corresponding to the vehicle control in the draggable state is displayed, the vehicle control in the fixed state may further be displayed, and the vehicle control is switched from the fixed state to the draggable state in response to a state switching instruction for the vehicle control in the fixed state.

The state switching instruction may be triggered by a control, or may be triggered by another operation.

In some aspects, the state switching instruction is triggered by the control. A switching control is displayed, the switching control being configured to switch the state of the vehicle control, and the state switching instruction for the vehicle control is received in response to a trigger operation on the switching control.

In some other aspects, the state switching instruction is triggered by a pressing operation. A pressing duration of the pressing operation is displayed in response to the pressing operation on the vehicle control, and the state switching instruction for the vehicle control is received when the pressing duration exceeds a target pressing duration.

The target pressing duration is preset. When the pressing operation on the vehicle control is received, the pressing duration of the pressing operation is obtained in real time, and the pressing duration is detected. When a detection result indicates that the pressing duration exceeds the target pressing duration, the state switching instruction for the vehicle control is received.

For example, FIG. 6 is a schematic diagram of a process of switching a vehicle control from a fixed state to a draggable state according to an aspect of this disclosure. Based on FIG. 6, as shown in a of FIG. 6, a vehicle control in the fixed state indicated by 601 is displayed, then when the pressing operation on the vehicle control is received, the pressing duration of the pressing operation is obtained in real time, and the pressing duration is detected. When the detection result indicates that the pressing duration exceeds the target pressing duration, the state switching instruction for the vehicle control is received, so that in response to the state switching instruction for the vehicle control in the fixed state, the vehicle control is switched from the fixed state to the draggable state indicated by a dashed box 602 in b of FIG. 6.

By applying the foregoing aspect, the state of the vehicle control in the fixed state is switched, so that after the vehicle control is switched from the fixed state to the draggable state, the vehicle switching instruction is triggered by dragging the vehicle control in the draggable state. In this way, the vehicle switching instruction can be triggered through the vehicle control only after the state of the vehicle control is switched. This not only avoids a case of an accidental touch by the user, improving accuracy of triggering the vehicle switching instruction, but also improves human-computer interaction efficiency and utilization of hardware resources of the electronic device.

In some aspects, the first virtual vehicle is determined through attribute parameters of virtual vehicles. The attribute parameters may be a level, a movable speed, that is, a maximum movement speed, endurance, control difficulty, a price, and the like of the first virtual vehicle, or the attribute parameters are determined based on the level, the movable speed, the endurance, the control difficulty, the price, and the like of the first virtual vehicle. Using an example in which the attribute parameter is the movable speed, in response to a movable speed of a fifth virtual vehicle in the at least one virtual vehicle reaching a movement speed threshold, the fifth virtual vehicle is determined as the first virtual vehicle, and the connecting element is controlled to connect the vehicle control and the fifth virtual vehicle.

The movement speed threshold may be determined based on movable speeds of the virtual vehicles, for example, a virtual vehicle having a maximum movable speed in the virtual vehicles. The movable speed of the fifth virtual vehicle in the at least one virtual vehicle reaches the movement speed threshold, that is, the movable speed of the fifth virtual vehicle in the at least one virtual vehicle is maximum. In this case, the virtual object is located outside the at least one virtual vehicle, and the at least one virtual vehicle may be in a static state or a movement state. This is not limited in the aspects of this disclosure.

In an actual application, the first virtual vehicle is determined through the attribute parameters of the virtual vehicles, that is, a virtual vehicle having a best attribute parameter is selected from the at least two virtual vehicles as the first virtual vehicle. In this way, this not only improves player experience and human-computer interaction efficiency, but also improves utilization of hardware resources.

In some aspects, when there are at least two virtual vehicles, the first virtual vehicle connected to the connecting element may further be switched. The process of switching the first virtual vehicle is described above. For example, the first virtual vehicle may be switched, in response to the vehicle switching instruction triggered based on the vehicle control, from the fifth virtual vehicle to a sixth virtual vehicle instructed by the vehicle switching instruction, and the connecting element is switched from connecting the vehicle control and the fifth virtual vehicle to connecting the vehicle control and the sixth virtual vehicle. The process of switching, in response to the vehicle switching instruction triggered based on the vehicle control, the first virtual vehicle from the fifth virtual vehicle to the sixth virtual vehicle instructed by the vehicle switching instruction, and switching the connecting element from connecting the vehicle control and the fifth virtual vehicle to connecting the vehicle control and the sixth virtual vehicle is similar to the foregoing process of switching, in response to the vehicle switching instruction triggered based on the vehicle control, the first virtual vehicle from the second virtual vehicle to the fourth virtual vehicle instructed by the vehicle switching instruction, and switching the connecting element from connecting the vehicle control and the second virtual vehicle to connecting the vehicle control and the fourth virtual vehicle. Details are not described in the aspects of this disclosure.

In some other aspects, the first virtual vehicle may be determined by the user. In response to a pressing operation on the vehicle control, when the pressing operation meets a pressing condition, the at least one virtual vehicle is controlled to be in a selectable state; in response to a selection operation on the first virtual vehicle in the at least one virtual vehicle, a seventh virtual vehicle is controlled to be in a selected state; and in response to a determining instruction for the seventh virtual vehicle in the selected state, the seventh virtual vehicle is determined as the first virtual vehicle, and the connecting element is controlled to connect the vehicle control and the seventh virtual vehicle.

The pressing condition may be preset. For example, when the duration of the pressing operation reaches the target pressing duration, or a pressing pressure of the pressing operation reaches a target pressing pressure, it is determined that the pressing operation meets the pressing condition. In addition, the determining instruction for the seventh virtual vehicle in the selected state may be triggered by a determining control. For example, the determining control is displayed, and the determining instruction for the seventh virtual vehicle in the selected state is received in response to a trigger operation on the determining control.

By applying the foregoing aspect, the at least one virtual vehicle is controlled to be in the selectable state based on the vehicle control, to select the seventh virtual vehicle as the first virtual vehicle from the at least one virtual vehicle in the selectable state. In this way, this not only gives the vehicle selection right to the user, making it easier for the user to directly select the vehicle and improving immersion and game experience of the user, but also improves human-computer interaction efficiency and utilization of hardware resources of the electronic device.

During actual implementation, when there are at least two virtual vehicles, the first virtual vehicle connected to the connecting element may further be switched. The process of switching the first virtual vehicle is described above. For example, the first virtual vehicle may be switched, in response to the vehicle switching instruction triggered based on the vehicle control, from the seventh virtual vehicle to another virtual vehicle instructed by the vehicle switching instruction, and the connecting element is switched from connecting the vehicle control and the seventh virtual vehicle to connecting the vehicle control and the another virtual vehicle. The process of switching, in response to the vehicle switching instruction triggered based on the vehicle control, the first virtual vehicle from the seventh virtual vehicle to the another virtual vehicle instructed by the vehicle switching instruction, and switching the connecting element from connecting the vehicle control and the seventh virtual vehicle to connecting the vehicle control and the another virtual vehicle is similar to the foregoing process of switching, in response to the vehicle switching instruction triggered based on the vehicle control, the first virtual vehicle from the second virtual vehicle to the fourth virtual vehicle instructed by the vehicle switching instruction, and switching the connecting element from connecting the vehicle control and the second virtual vehicle to connecting the vehicle control and the fourth virtual vehicle. Details are not described in the aspects of this disclosure.

During actual implementation, after the first virtual vehicle is determined through the distance to the virtual object and the first virtual vehicle is determined through the attribute parameters of the virtual vehicles, the process of determining the first virtual vehicle by the user may further be implemented, that is, the process of switching the first virtual vehicle, so that the vehicle switching instruction described above is the determining instruction for the virtual vehicle in the selected state, for example, the seventh virtual vehicle. A process of switching, in response to the vehicle switching instruction triggered based on the vehicle control, the first virtual vehicle from the second virtual vehicle to the fourth virtual vehicle instructed by the vehicle switching instruction is a process of controlling, in response to the pressing operation on the vehicle control, when the pressing operation meets the pressing condition, the at least one virtual vehicle to be in the selectable state; controlling, in response to a selection operation on the fourth virtual vehicle in the at least one virtual vehicle, the fourth virtual vehicle to be in the selected state; and switching, in response to a determining instruction for the fourth virtual vehicle in the selected state, the first virtual vehicle from the second virtual vehicle to the fourth virtual vehicle instructed by the vehicle switching instruction.

Correspondingly, a process of switching, in response to the vehicle switching instruction triggered based on the vehicle control, the first virtual vehicle from the fifth virtual vehicle to the sixth virtual vehicle instructed by the vehicle switching instruction, and switching the connecting element from connecting the vehicle control and the fifth virtual vehicle to connecting the vehicle control and the sixth virtual vehicle is controlling, in response to the pressing operation on the vehicle control, when the pressing operation meets the pressing condition, the at least one virtual vehicle to be in the selectable state; controlling, in response to the selection operation on the sixth virtual vehicle in the at least one virtual vehicle, the sixth virtual vehicle to be in the selected state; and switching, in response to a determining instruction for the sixth virtual vehicle in the selected state, the first virtual vehicle from the fifth virtual vehicle to the sixth virtual vehicle instructed by the vehicle switching instruction.

In some aspects, no matter how to determine the first virtual vehicle, attribute information of the first virtual vehicle may further be displayed at an associated position of the vehicle control. The attribute information includes at least one of the following: a level, a vehicle name, a movable speed, endurance, control difficulty, or a price of the first virtual vehicle. The level of the first virtual vehicle is determined based on the attribute parameters described above, the movable speed is a maximum moving speed of the virtual vehicle, the endurance is current endurance of the virtual vehicle, the control difficulty is driving operating difficulty of the virtual vehicle, and the price is a price at which the virtual vehicle can be purchased and used. The associated position of the virtual vehicle may be one of an upper position, a lower position, a left side position, and a right side position of the virtual vehicle.

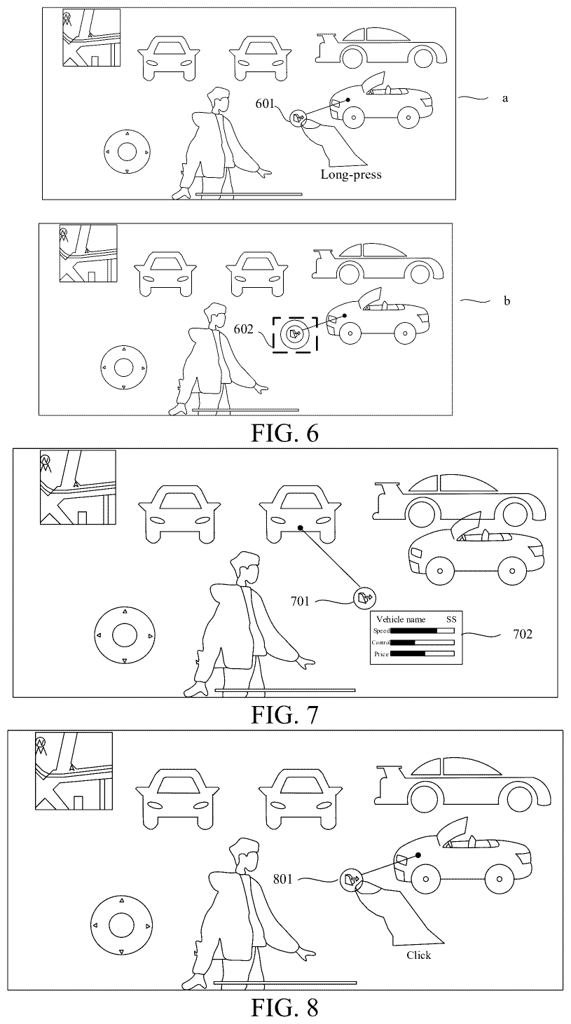

For example, FIG. 7 is a schematic diagram of displaying attribute information of a first virtual vehicle according to an aspect of this disclosure. Based on FIG. 7, attribute information indicated by 702 of the first virtual vehicle is displayed in a right side region of a vehicle control indicated by 701. The attribute information includes the level, the vehicle name, the movable speed, the control difficulty, and the price of the first virtual vehicle.

During actual implementation, when the attribute information of the first virtual vehicle is displayed at the associated position of the vehicle control, if there are at least two virtual vehicles, when the first virtual vehicle is not switched, the displayed attribute information remains unchanged even if the virtual object moves. When the first virtual vehicle is switched, the displayed attribute information is switched. Using an example in which the first virtual vehicle is determined through the attribute parameters of the virtual vehicles, attribute information of the fifth virtual vehicle is displayed at the associated position of the vehicle control; the first virtual vehicle is switched, in response to the vehicle switching instruction triggered based on the vehicle control, from the fifth virtual vehicle to the sixth virtual vehicle instructed by the vehicle switching instruction; and at the associated position of the vehicle control, display of the attribute information of the fifth virtual vehicle is switched to display of attribute information of the sixth virtual vehicle, and the connecting element is switched from connecting the vehicle control and the fifth virtual vehicle to connecting the vehicle control and the sixth virtual vehicle.

When the first virtual vehicle is determined by using the distance to the virtual object and the first virtual vehicle is determined by the user, a process of switching display of the attribute information is similar to a process of switching display of the attribute information when the first virtual vehicle is determined through the attribute parameters of the virtual vehicles. Details are not described in this disclosure.

In an actual application, the attribute information of the first virtual vehicle is displayed at the associated position of the first virtual vehicle, making it easier for the user to determine a to-be-entered virtual vehicle. In this way, this not only improves human-computer interaction efficiency and utilization of hardware resources of the electronic device, but also improves game experience of the user.

Operation 102: Control, in response to a trigger operation on the vehicle control, a virtual object to automatically enter the first virtual vehicle associated with the vehicle control. For example, based on the trigger operation performed on the vehicle entry control element when the vehicle entry control element is associated with the first virtual vehicle, the virtual object is controlled to automatically enter the first virtual vehicle associated with the vehicle entry control element.

During actual implementation, when the first virtual vehicle is determined, the virtual object may be controlled, in response to the trigger operation on the vehicle control, to automatically enter the first virtual vehicle associated with the vehicle control. The trigger operation may be a click operation such as a one-click operation or a double-click operation, or may be another operation.

In some aspects, the trigger operation is the click operation such as the one-click operation or the double-click operation, so that a process of controlling, in response to the trigger operation on the vehicle control, the virtual object to automatically enter the first virtual vehicle associated with the vehicle control may be a process of presenting, in response to the trigger operation on the vehicle control, a process in which the virtual object moves to the first virtual vehicle, and controlling, when the virtual object moves into a sensing region of the first virtual vehicle, the virtual object to enter the first virtual vehicle.

The sensing region is a circular region with the first virtual vehicle as a center and a target distance as a radius. For a process of determining whether the virtual object moves into the sensing region of the first virtual vehicle, a position of the first virtual vehicle is obtained, and a position of the virtual object is obtained in real time; and a real-time distance between the virtual object and the first virtual vehicle is determined based on the position of the first virtual vehicle and the position of the virtual object, and when the real-time distance is less than or equal to the target distance, it is determined that the virtual object moves into the sensing region of the first virtual vehicle, the target distance being preset.

In addition, if there are at least two virtual vehicles, when the trigger operation is the click operation such as the one-click operation or the double-click operation, after the first virtual vehicle is switched, and the vehicle switching instruction is triggered by the dragging operation on the vehicle control, the dragging operation on the vehicle control is first released, and then a process in which the virtual object moves to the first virtual vehicle is presented by clicking the vehicle control.

For example, FIG. 8 is a schematic diagram of a process of controlling a virtual object to automatically enter a first virtual vehicle associated with a vehicle control according to an aspect of this disclosure. Based on FIG. 8, a process in which the virtual object moves to the first virtual vehicle is presented in response to a click operation on a vehicle control indicated by 801; and when the virtual object moves to the first virtual vehicle, the virtual object is controlled to enter the first virtual vehicle.

By applying the foregoing aspects, by clicking the vehicle control by the user, the virtual object may automatically move into the sensing region of the first virtual vehicle, to directly enter the first virtual vehicle again. In this way, the virtual object does not need to be manually moved beside a corresponding virtual vehicle and then enter the virtual vehicle, thereby improving efficiency of the virtual object entering the virtual vehicle, human-computer interaction efficiency, and utilization of hardware resources of the electronic device.

In some other aspects, there are at least two virtual vehicles, the trigger operation includes the dragging operation on the vehicle control and a release operation on the dragging operation, the first virtual vehicle is an eighth virtual vehicle in the at least two virtual vehicles, and the connecting element connects the vehicle control and the eighth virtual vehicle. Therefore, a process of controlling, in response to the trigger operation on the vehicle control, the virtual object to automatically enter the first virtual vehicle associated with the vehicle control may be: determining, in response to the dragging operation on the vehicle control, when the vehicle control is dragged to a ninth virtual vehicle, the ninth virtual vehicle as the first virtual vehicle, and switching the connecting element from connecting the vehicle control and the first virtual vehicle to connecting the vehicle control and the ninth virtual vehicle; and controlling, in response to the release operation on the dragging operation, the virtual object to automatically enter the ninth virtual vehicle associated with the vehicle control.

When the trigger operation includes the dragging operation on the vehicle control and the release operation on the dragging operation, after the first virtual vehicle is switched, and the vehicle switching instruction is triggered by the dragging operation on the vehicle control, the dragging operation on the vehicle control is released, and then a process in which the virtual object moves to the first virtual vehicle is presented, that is, the vehicle control does not need to be clicked again, and when the dragging operation on the vehicle control is released, the virtual object is directly controlled to move to the first virtual vehicle.

In an actual application, the first virtual vehicle is switched by dragging the vehicle control. In this way, this not only gives the vehicle selection right to the user, making it easier for the user to directly select the vehicle and improving immersion and game experience of the user, human-computer interaction efficiency, and utilization of hardware resources of the electronic device, but also simplifies a process of switching the first virtual vehicle, improving vehicle switching efficiency.

For presenting the process in which the virtual object moves to the first virtual vehicle, movement is the virtual object approaching the first virtual vehicle, and there may be a plurality of movement manners based on a type of the first virtual vehicle. For example, the first virtual vehicle includes at least one of a land conveyance, a boat type conveyance, or a flying type conveyance. Based on different types of first virtual vehicles, processes of controlling, in response to the trigger operation on the vehicle control, the virtual object to automatically enter the first virtual vehicle associated with the vehicle control are also different.

For example, when the first virtual vehicle includes the boat type conveyance, the first virtual vehicle is located in water, so that the process of controlling, in response to the trigger operation on the vehicle control, the virtual object to automatically enter the first virtual vehicle associated with the vehicle control may be: controlling, in response to the trigger operation on the vehicle control, the virtual object to enter water and navigate from a current position to a position of the first virtual vehicle; and controlling, when the virtual object navigates to the position of the first virtual vehicle, the virtual object to leave water and enter the first virtual vehicle.

Alternatively, when the first virtual vehicle includes the boat type conveyance, the first virtual vehicle is located in air, so that the process of controlling, in response to the trigger operation on the vehicle control, the virtual object to automatically enter the first virtual vehicle associated with the vehicle control may be: controlling, in response to the trigger operation on the vehicle control, the virtual object to jump from a current position on a ground of the virtual scenario to a position of the first virtual vehicle in air and enter an interior of the first virtual vehicle.

The at least one virtual vehicle may include a plurality of types of virtual vehicles. Correspondingly, when the first virtual vehicle includes a land conveyance, for example, a virtual car, in response to the trigger operation on the vehicle control, a process of controlling the virtual object to automatically enter the first virtual vehicle associated with the vehicle control may be directly teleporting the virtual object into the first virtual vehicle, or controlling the virtual object to jump into the first virtual vehicle, or controlling the virtual object to fly into the first virtual vehicle, or controlling the virtual object to crawl or walk into the first virtual vehicle. This is not limited in the aspects of this disclosure.

By applying the foregoing aspects, for different types of virtual vehicles, manners in which the virtual object enters the virtual vehicle are different. In this way, a process in which the virtual object enters the virtual vehicle is enriched, thereby not only immersion and game experience of the user are improved, but also human-computer interaction efficiency and utilization of hardware resources of the electronic device are improved.

In some aspects, in the process in which the virtual object moves to the first virtual vehicle, a distance progress bar may further be displayed in an associated region of the vehicle control. A progress displayed by the distance progress bar increases as a distance between the virtual object and the first virtual vehicle decreases, and the distance progress bar is configured for indicating a proportion of a movement distance of the virtual object to a total distance between the virtual object and the first virtual vehicle.

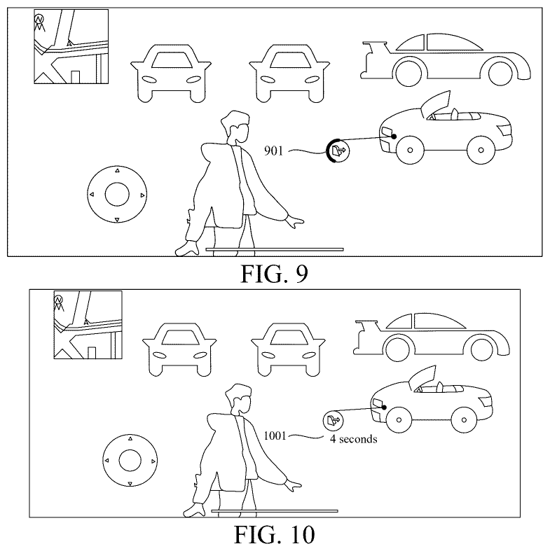

The associated region may be one of an upper region, a lower region, a left side region, and a right side region of the vehicle control, and a region in which the vehicle control is located. A style of the distance progress bar may be preset, for example, a long strip shape or a round shape. The user may move to the first virtual vehicle according to the distance progress bar. For example, FIG. 9 is a schematic diagram of a distance progress bar according to an aspect of this disclosure. Based on FIG. 9, a distance progress bar indicated by 901 is displayed in a region in which the vehicle control is located. In this way, this avoids a case in which in a process of automatically finding paths and entering the vehicle, because the progress cannot be perceived, the player needs to perform subjective determining through a distance to the vehicle, and when the player mistakenly thinks that the player already reaches the virtual vehicle, the player performs an operation of character displacement and interrupts the process of entering the virtual vehicle. Through the distance progress bar, the user may perceive a behavior of interrupting the virtual vehicle by an accidental touch operation in a current process of moving and finding paths, thereby reducing a behavior of interrupting the virtual vehicle by the accidental touch operation.

In some aspects, in the process in which the virtual object moves to the first virtual vehicle, a countdown may further be displayed in the associated region of the vehicle control in the process in which the virtual object moves to the first virtual vehicle. The countdown is configured for indicating a required duration for the virtual object to move to the first virtual vehicle.

The associated region may be one of an upper region, a lower region, a left side region, and a right side region of the vehicle control. For example, FIG. 10 is a schematic diagram of a countdown according to an aspect of this disclosure. Based on FIG. 10, a countdown indicated by 1001 is displayed in the lower region of the vehicle control. In this way, this avoids a case in which in a process of automatically finding paths and entering the vehicle, because the progress cannot be perceived, the player needs to perform subjective determining through a distance to the vehicle, and when the player mistakenly thinks that the player already reaches the virtual vehicle, the player performs an operation of character displacement and interrupts the process of entering the virtual vehicle. By using the countdown, the user may perceive a behavior of interrupting the virtual vehicle by a false touch operation in a current process of moving and finding paths, thereby reducing a behavior of interrupting the virtual vehicle by the accidental touch operation. In addition, the countdown may further be used to make the player perceive an accurate time of entering the virtual vehicle, thereby facilitating the player to perform a next operation.

In some aspects, when there are at least two virtual vehicles, after the virtual object is controlled, in response to the trigger operation on the vehicle control, to automatically enter the first virtual vehicle associated with the vehicle control, the virtual vehicle entered by the virtual object may further be switched, and the virtual object is controlled, in response to the vehicle switching instruction triggered based on the vehicle control, to leave from the first virtual vehicle and automatically enter a tenth virtual vehicle in at least one of other virtual vehicles, the other virtual vehicles being virtual vehicles other than the first virtual vehicle in the at least two virtual vehicles, and the tenth virtual vehicle being a virtual vehicle instructed by the vehicle switching instruction to switch to.

During actual implementation, as described above, the first virtual vehicle may be determined through the distance to the virtual object, or may be determined through the attribute parameters of the virtual vehicles, or may be determined by the user. Based on this, the tenth virtual vehicle may be a virtual vehicle closest to the virtual object in the other virtual vehicles, or may be a virtual vehicle having a largest attribute parameter value in the other virtual vehicles, or may be determined by the user. When the tenth virtual vehicle is the virtual vehicle closest to the virtual object in the other virtual vehicles, or is the virtual vehicle having the largest attribute parameter value in the other virtual vehicles, the vehicle switching instruction triggered based on the vehicle control may be triggered by the click operation on the vehicle control, that is, in response to the click operation on the vehicle control, the virtual object is controlled to leave from the first virtual vehicle and automatically enter the tenth virtual vehicle in the at least one of other virtual vehicles.

When the tenth virtual vehicle is determined by the user, the vehicle switching instruction triggered based on the vehicle control may be triggered by the pressing operation on the vehicle control and a selection operation on the tenth virtual vehicle, that is, the at least one of other virtual vehicles that can be selected is displayed in response to the pressing operation on the vehicle control, and the virtual object is controlled to leave from the first virtual vehicle and automatically enter the tenth virtual vehicle in the at least one of other virtual vehicles in response to the selection operation on the tenth virtual vehicle in the at least one of other virtual vehicles.

By applying the foregoing aspect, after the virtual object enters the virtual vehicle, the virtual vehicle can further be switched based on the vehicle control. In this way, not only game experience of the player and utilization of the vehicle control are improved, but also human-computer interaction efficiency and utilization of hardware resources of the electronic device are improved. In addition, compared with a solution in which the virtual object needs to be manually controlled to leave the virtual vehicle and then enter another virtual vehicle, virtual vehicle switching efficiency is also improved.

In some aspects, only a user having a permission can use the vehicle control. A process of displaying at least one virtual vehicle and a vehicle control in a virtual scenario may be displaying, in a virtual scenario, at least one virtual vehicle and a vehicle control in an inactive state. The inactive state is configured for indicating that the virtual object does not have a use permission for the vehicle control. Therefore, after the at least one virtual vehicle and the vehicle control are displayed in the virtual scenario, the vehicle control may further be controlled to be switched from the inactive state to an active state in response to the virtual object having the use permission for the vehicle control. A process of controlling, in response to the trigger operation on the vehicle control, the virtual object to automatically enter the first virtual vehicle associated with the vehicle control may be controlling, in response to the trigger operation on the vehicle control in the active state, the virtual object to automatically enter the first virtual vehicle associated with the vehicle control.

The use permission for the vehicle control may be determined based on an object level of the virtual object, a level of an account controlling the virtual object, game data of the virtual object, and the like. Before the at least one virtual vehicle and the vehicle control are displayed, object information of the virtual object is obtained, the object information including the object level of the virtual object, the level of the account controlling the virtual object, the game data of the virtual object, and the like. Permission detection is performed on the virtual object based on the object information of the virtual object, to obtain a detection result configured for indicating whether the virtual object has the use permission for the vehicle control. Therefore, when the detection result indicates that the virtual object has the use permission for the vehicle control, the at least one virtual vehicle and the vehicle control in the active state are displayed, and when the detection result indicates that the virtual object does not have the use permission for the vehicle control, the at least one virtual vehicle and the vehicle control in the inactive state are displayed.

In an actual application, whether the virtual object has the use permission for the vehicle control is determined, and whether to display a vehicle control that can be used by the user is determined. In this way, diversity of interaction based on the vehicle control in the virtual scenario is improved, and human-computer interaction efficiency and utilization of hardware resources of the electronic device are also improved.

During actual implementation, the virtual object may obtain the use permission for the vehicle control by executing an interaction task. In response to the virtual object having the use permission for the vehicle control, before the vehicle control is controlled to be switched from the inactive state to the active state, the interaction task and task guidance information may be further displayed, the task guidance information being configured for guiding the virtual object to execute the interaction task; in response to a task execution operation that is performed on the interaction task and that is triggered based on the task guidance information, a process in which the virtual object executes the interaction task is displayed; and when the virtual object completes the interaction task, the virtual object is controlled to have the use permission for the vehicle control.

The task guidance information may be in a text form, an image form, or a video form. This is not limited in the aspects of this disclosure. The interaction task may be watching a promotion video related to an application program corresponding to the virtual scenario, sharing promotion information related to an application program corresponding to the virtual scenario, or completing a mini game related to an application program corresponding to the virtual scenario. When the interaction task is watching the promotion video related to the application program corresponding to the virtual scenario, if the virtual object does not have the use permission for the vehicle control, when the trigger operation on the vehicle control in the inactive state is received, the promotion video is played, and a watching duration of the promotion video is displayed; and when the watching duration reaches a target watching duration, it is determined that the interaction task is completed. When the interaction task is sharing the promotion information related to the application program corresponding to the virtual scenario, if the virtual object does not have the use permission for the vehicle control, when the trigger operation on the vehicle control in the inactive state is received, a sharing control configured to share the promotion information is displayed; and when a sharing operation triggered based on the sharing control is received, it is determined that the interaction task is completed. When the interaction task is completing the mini game related to the application program corresponding to the virtual scenario, if the virtual object does not have the use permission for the vehicle control, when the trigger operation on the vehicle control in the inactive state is received, a game interface is displayed, and an execution result of a game execution operation is displayed on the game interface in response to the game execution operation; and when the execution result indicates that the game is completed, it is determined that the interaction task is completed. Based on this, when the interaction task is completed, the virtual object is controlled to have the use permission for the vehicle control.

After the virtual object is controlled to have the use permission for the vehicle control, prompt information may be displayed. The prompt information is configured for prompting that the virtual object is controlled to have the use permission for the vehicle control and can use the vehicle control. In this way, based on the set interaction task, the virtual object can be controlled to have the use permission for the vehicle control, thereby not only enriching diversity of interaction manners in an interaction process of the virtual object, but also improving human-computer interaction efficiency and utilization of hardware resources.

By applying the foregoing aspect of this disclosure, when a virtual vehicle is displayed in a virtual scenario, a vehicle control and a connecting element configured for indicating an association relationship between the vehicle control and a first virtual vehicle are further displayed, to control, based on the connecting element and in response to a trigger operation on the vehicle control, a virtual object to automatically enter the first virtual vehicle associated with the vehicle control. In this way, compared with a solution in which the virtual object needs to be manually moved beside a corresponding vehicle and then enters the vehicle, a solution in which when a trigger operation performed by a user on the vehicle control is received, the virtual object is controlled to automatically enter the first virtual vehicle associated with the vehicle control improves efficiency of the virtual object entering the vehicle. In addition, based on the connecting element configured for indicating the association relationship between the vehicle control and the first virtual vehicle, a virtual vehicle that can be entered based on the vehicle control is clarified, that is, a virtual vehicle to be entered by the virtual object is clarified. This not only improves accuracy of the virtual object entering the vehicle, further improving efficiency of the virtual object entering the vehicle, but also improves human-computer interaction efficiency and utilization of hardware resources of an electronic device.

The following describes an example application of this aspect of this disclosure.

In a game in the related technology, when a player needs to enter a vehicle in at least one vehicle, a virtual object controlled by the player needs to be manually moved beside a corresponding vehicle, and then enter the vehicle. In addition, if a distance between the vehicle and another vehicle is excessively small, when the player moves beside the vehicle, the vehicle which the player intends to enter may not be accurately selected, that is, may randomly enter one of the vehicles. Based on this, efficiency and accuracy of the virtual object entering the vehicle in the related technology are low.

Based on this, the aspects of this disclosure provide a method and an apparatus for controlling a virtual object, an electronic device, a computer-readable storage medium, and a computer program product. For problems that when a plurality of vehicles exist at the same time, the player cannot intuitively determine and select a to-be-boarded vehicle, and low efficiency of an operation of boarding the vehicle, intuitive connection guidance is added to a vehicle button, so that the player can intuitively determine which vehicle is triggered after clicking a boarding button. In addition, when at least one vehicle is in a viewframe at the same time, the player may long-press and drag the boarding button, and the button may change to a form of a joystick. The joystick is dragged to switch the to-be-boarded vehicle, and a corresponding line may also connect different vehicles in the viewframe according to a joystick shaking direction, so that the player can accurately select the to-be-boarded vehicle when the plurality of vehicles exist at the same time. In addition, after the boarding button is triggered, a player character image may perform automatic vehicle finding, and a countdown progress from automatic vehicle finding to boarding the vehicle may be displayed on the button, so that the player can sense a progress from the automatic vehicle finding to boarding the vehicle, thereby reducing a behavior of interruption of boarding the vehicle due to an accidental touch operation.

Next, technical solutions of this disclosure are described from a product side.

During actual implementation, as shown in FIG. 4, when vehicles are displayed in a game scenario (a virtual scenario), a boarding button (a vehicle control) is displayed. The button is connected, by using a line (a connecting element), to a closest vehicle that can be boarded in the displayed vehicles in the game scenario. When at least two vehicles exist at the same time, the to-be-boarded vehicle is conveniently selected. When a click operation performed by a player on the boarding button is received, as shown in FIG. 9, a countdown progress bar is displayed on the button, which indicates a process in which a character is automatically searching for the vehicle and going to the vehicle. In addition, a game character (virtual object) is controlled to automatically move to a position of the vehicle, and the player does not need to perform an additional operation. After the game character reaches the position of the vehicle, the game character automatically boards the vehicle.

In some aspects, the player may further select another vehicle. As shown in FIG. 5 and FIG. 6, when a long-press operation performed by the player on the boarding button is received, the boarding button is controlled to be switched to a joystick (the vehicle control is controlled to be switched from a fixed state to a draggable state), so that a to-be-boarded vehicle is switched in response to a shaking operation (a dragging operation) on the joystick. A corresponding line may be connected to different vehicles in the viewframe according to a joystick shaking direction. Then, when a release operation performed by the player on the joystick is received, the character automatically searches for and goes to a selected vehicle. After reaching a position of the vehicle, the character automatically boards the vehicle.

Next, technical solutions of this disclosure are described from a technology side.

During actual implementation, the technical solutions of this disclosure are completed through four implementation processes, that is, an implementation process of visual connection, an implementation process of automatic vehicle finding, an implementation process of a countdown progress bar, and an implementation process of vehicle switching.

For the implementation process of visual connection, a visual connecting line module needs to be added to a rendering engine of a game, and a main task is to draw a visual connecting line between a boarding button and a vehicle that can be boarded closest within a viewing angle box. To implement this function, during rendering of each frame, first, position information of all vehicles within the viewing angle box is traversed, and then a closest vehicle is found by calculating a distance between each vehicle and a character. Then, a new line object needs to be created, a start point of the line object is set as a position of the boarding button, and an end point is a position of the closest vehicle, and then the line object is added to a rendering queue.

For the implementation process of automatic vehicle finding, in a character control system of the game, after the player clicks the boarding button, the character is automatically controlled to move to a vehicle connected to the visual connecting line. To implement this function, during updating of each frame, position information of the character and the closest vehicle needs to be first obtained, and then a path planning algorithm is used to calculate a shortest path of the character from a current position to a position of the vehicle. Then, a distance and a direction that the character is to move in each frame are calculated according to the path and a movement speed of the character, and then a position of the character is updated.

For the implementation process of a countdown progress bar, after the player clicks the boarding button, a countdown progress bar is displayed on the button. To implement this function, during updating of each frame, a current position of the character and the position of the closest vehicle need to be first obtained, and then a total distance between the character and the vehicle is calculated. Then, a total time required by the character to reach the vehicle needs to be calculated according to the movement speed of the character. Then, a progress of the countdown progress bar needs to be calculated according to an elapsed time and the total time, and then display of the progress bar is updated.

For the implementation process of vehicle switching, in an input processing system of the game, when the player long-presses and drags the boarding button, the vehicle connected to the visual connecting line may be switched to. To implement this function, during updating of each frame, input information of the player needs to be first obtained, and then an input direction of the player needs to be calculated according to the information. Then, the position information of all vehicles within the viewing angle box needs to be traversed according to the direction, to find a closest vehicle in the direction. Then, the end point of the visual connecting line needs to be updated to the position of the vehicle.

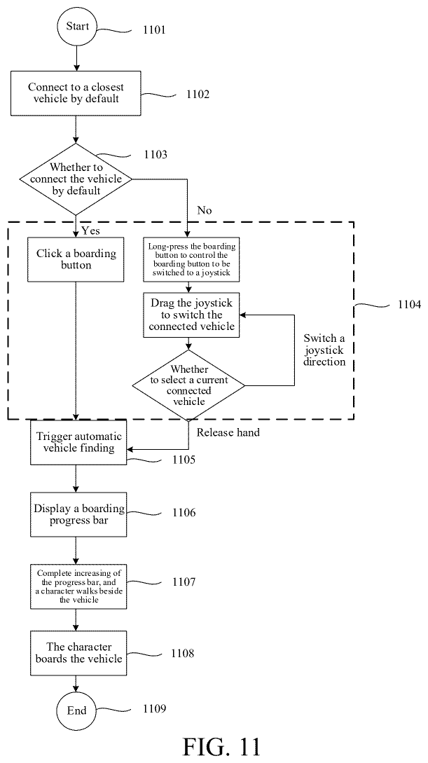

During actual implementation, FIG. 11 is a schematic flowchart of an operation solution for accurate selection of boarding a vehicle when a plurality of vehicles are provided according to an aspect of this disclosure. Based on FIG. 11, the operation solution for accurate selection of boarding a vehicle when a plurality of vehicles are provided according to this aspect of this disclosure are implemented through operation 1101 to operation 1109. First, a connecting line is displayed, the connecting line connecting a boarding button and a vehicle closest to a character, and when the user determines to enter the vehicle connected to the connecting line, the user clicks the boarding button, to control the character to automatically find the vehicle in response to a click operation on the boarding button. When the user does not enter the vehicle connected to the connecting line, the user long-presses the boarding button, to control the boarding button to be switched to a joystick in response to a long-press operation on the boarding button. Then, the user switches the connected vehicle by dragging the joystick. When it is determined that the currently connected vehicle is entered, the user loosens the joystick, to control the character to automatically find the vehicle in response to a release operation on the joystick. Then, in a process of automatic vehicle finding, a boarding progress bar is displayed, and when increasing of the progress bar is completed, the character goes to the corresponding vehicle, to control the character to enter the vehicle.

In some aspects, when the player long-presses, drags, and switches the vehicle, a corresponding vehicle basic attribute panel of a link is further displayed, including a name and a basic value, to assist the player in making an instant selection. In this way, the player can quickly view the basic value and a rarity of the vehicle without entering a detail interface. As shown in FIG. 7, a connecting line is displayed. The connecting line is connected by default to a vehicle having a highest attribute value and a highest rarity. When a configuration value and the rarity are the same, a link is determined by default to be a closest distance. When a long-press operation performed by the player on the boarding button is received, the boarding button is controlled to be switched to a joystick. Then, in response to a dragging operation performed by the player on the joystick, a vehicle attribute panel of the vehicle currently connected to the connecting line is displayed. In this way, the player is assisted to select the vehicle, to determine whether to switch to a different vehicle. Finally, based on the vehicle attribute panel, when a release operation performed by the player on the joystick is received, the character is controlled to automatically move to the vehicle corresponding to the vehicle attribute panel, and enter the vehicle.

In this way, in this disclosure, visual line guidance is introduced, so that the player sees a vehicle that is currently selected more clearly. The player is given a manner of quickly triggering a vehicle, and a manner of freely selecting to switch a vehicle, which not only improves operation efficiency of the player, increases an automatic vehicle finding function, but also reduces operation costs of the player.

By applying the foregoing aspect of this disclosure, when a virtual vehicle is displayed in a virtual scenario, a vehicle control and a connecting element configured for indicating an association relationship between the vehicle control and a first virtual vehicle are further displayed, to control, based on the connecting element and in response to a trigger operation on the vehicle control, a virtual object to automatically enter the first virtual vehicle associated with the vehicle control. In this way, compared with a solution in which the virtual object needs to be manually moved beside a corresponding vehicle and then enters the vehicle, a solution in which when a trigger operation performed by a user on the vehicle control is received, the virtual object is controlled to automatically enter the first virtual vehicle associated with the vehicle control improves efficiency of the virtual object entering the vehicle. In addition, based on the connecting element configured for indicating the association relationship between the vehicle control and the first virtual vehicle, a virtual vehicle that can be entered based on the vehicle control is clarified, that is, a virtual vehicle to be entered by the virtual object is clarified. This not only improves accuracy of the virtual object entering the vehicle, further improving efficiency of the virtual object entering the vehicle, but also improves human-computer interaction efficiency and utilization of hardware resources of an electronic device.

The following continues to describe an example structure in which the apparatus for controlling a virtual object 455 provided in the aspects of this disclosure is implemented as a software module. In some aspects, as shown in FIG. 2, the software module stored in the apparatus for controlling a virtual object 455 of the memory 450 may include:
a display module 4551, configured to display at least one virtual vehicle and a vehicle control in a virtual scenario, a connecting element existing between the vehicle control and a first virtual vehicle in the at least one virtual vehicle, and the connecting element being configured for indicating a virtual vehicle associated with the vehicle control; and
a control module 4552, configured to control, in response to a trigger operation on the vehicle control, a virtual object to automatically enter the first virtual vehicle associated with the vehicle control.

In some aspects, the control module 4552 is further configured to present, in response to the trigger operation on the vehicle control, a process in which the virtual object moves to the first virtual vehicle; and control, when the virtual object moves into a sensing region of the first virtual vehicle, the virtual object to enter the first virtual vehicle.

In some aspects, the apparatus further includes a second display module, and the second display module is configured to display a distance progress bar in an associated region of the vehicle control in the process in which the virtual object moves to the first virtual vehicle, a progress displayed by the distance progress bar increasing as a distance between the virtual object and the first virtual vehicle decreases, and the distance progress bar being configured for indicating a proportion of a movement distance of the virtual object to a total distance between the virtual object and the first virtual vehicle.

In some aspects, the apparatus further includes a third display module, and the third display module is further configured to display a countdown in an associated region of the vehicle control in the process in which the virtual object moves to the first virtual vehicle, the countdown being configured for indicating a required duration for the virtual object to move to the first virtual vehicle.

In some aspects, the apparatus further includes a second control module, and the second control module is configured to determine, in response to a distance between the virtual object and a second virtual vehicle in the at least one virtual vehicle meeting a distance condition, the second virtual vehicle as the first virtual vehicle, and control the connecting element to connect the vehicle control and the second virtual vehicle.

In some aspects, a quantity of virtual vehicles is at least two, the apparatus further includes a first switching module, and the first switching module is configured to control, in response to a movement instruction for the virtual object, the virtual object to move; and determine, in a movement process of the virtual object, in response to a virtual vehicle in the at least two virtual vehicles that meets the distance condition being switched from the second virtual vehicle to a third virtual vehicle, the third virtual vehicle as the first virtual vehicle, and switch the connecting element from connecting the vehicle control and the second virtual vehicle to connecting the vehicle control and the third virtual vehicle.

In some aspects, the quantity of virtual vehicles is at least two, the apparatus further includes a second switching module, and the second switching module is configured to switch, in response to a vehicle switching instruction triggered based on the vehicle control, the first virtual vehicle from the second virtual vehicle to a fourth virtual vehicle instructed by the vehicle switching instruction, and switch the connecting element from connecting the vehicle control and the second virtual vehicle to connecting the vehicle control and the fourth virtual vehicle.

In some aspects, the vehicle control is in a draggable state, the apparatus further includes a fourth display module, and the fourth display module is configured to display a draggable region corresponding to the vehicle control in the draggable state; and receive, in response to a dragging operation that is performed on the vehicle control and that is performed in the draggable region, when a dragging angle of the dragging operation reaches a dragging angle threshold, the vehicle switching instruction triggered based on the vehicle control.

In some aspects, the apparatus further includes a state switching module, and the state switching module is configured to display the vehicle control in a fixed state; and switch the vehicle control from the fixed state to the draggable state in response to a state switching instruction for the vehicle control in the fixed state.

In some aspects, the apparatus further includes a third control module, and the third control module is configured to determine, in response to a movable speed of a fifth virtual vehicle in the at least one virtual vehicle reaching a movement speed threshold, the fifth virtual vehicle as the first virtual vehicle, and control the connecting element to connect the vehicle control and the fifth virtual vehicle.

In some aspects, the quantity of virtual vehicles is at least two, the apparatus further includes a third switching module, and the third switching module is configured to display attribute information of the fifth virtual vehicle at an associated position of the vehicle control; switch, in response to the vehicle switching instruction triggered based on the vehicle control, the first virtual vehicle from the fifth virtual vehicle to a sixth virtual vehicle instructed by the vehicle switching instruction; and switch, at the associated position of the vehicle control, display of the attribute information of the fifth virtual vehicle to display of attribute information of the sixth virtual vehicle, and switch the connecting element from connecting the vehicle control and the fifth virtual vehicle to connecting the vehicle control and the sixth virtual vehicle.

In some aspects, the apparatus further includes a fourth control module, and the fourth control module is configured to control, in response to a pressing operation on the vehicle control, when the pressing operation meets a pressing condition, the at least one virtual vehicle to be in a selectable state; control, in response to a selection operation on a seventh virtual vehicle in the at least one virtual vehicle, the seventh virtual vehicle to be in a selected state; and determine, in response to a determining instruction for the seventh virtual vehicle in the selected state, the seventh virtual vehicle as the first virtual vehicle, and control the connecting element to connect the vehicle control and the seventh virtual vehicle.

In some aspects, the quantity of virtual vehicles is at least two, the trigger operation includes the dragging operation on the vehicle control and a release operation on the dragging operation, the first virtual vehicle is an eighth virtual vehicle in the at least two virtual vehicles, and the connecting element connects the vehicle control and the eighth virtual vehicle; and the control module 4552 is further configured to determine, in response to the dragging operation on the vehicle control, when the vehicle control is dragged to a ninth virtual vehicle, the ninth virtual vehicle as the first virtual vehicle, and switch the connecting element from connecting the vehicle control and the first virtual vehicle to connecting the vehicle control and the ninth virtual vehicle; and control, in response to the release operation on the dragging operation, the virtual object to automatically enter the ninth virtual vehicle associated with the vehicle control.

In some aspects, the apparatus further includes a fifth display module, and the fifth display module is configured to display the virtual object in the virtual scenario, the virtual object being located outside a sensing range of the at least one virtual vehicle; and control the virtual object to move to the at least one virtual vehicle in response to the movement instruction for the virtual object; and the display module 4551 is further configured to display the vehicle control when the virtual object moves into the sensing range of the at least one virtual vehicle.

In some aspects, the quantity of virtual vehicles is at least two, the apparatus further includes a fifth control module, and the fifth control module is configured to control, in response to the vehicle switching instruction triggered based on the vehicle control, the virtual object to leave from the first virtual vehicle and automatically enter a tenth virtual vehicle in at least one of other virtual vehicles, the other virtual vehicles being virtual vehicles in the at least two virtual vehicles other than the first virtual vehicle, and the tenth virtual vehicle being a virtual vehicle instructed by the vehicle switching instruction to switch to.

In some aspects, the first virtual vehicle includes at least one of a boat type conveyance or a flying type conveyance, when the first virtual vehicle includes the boat type conveyance, the first virtual vehicle is located in water, and when the first virtual vehicle includes the flying type conveyance, the first virtual vehicle is located in air; and the control module 4552 is further configured to control, when the virtual vehicle includes the boat type conveyance, in response to the trigger operation on the vehicle control, the virtual object to enter water and navigate from a current position to a position of the first virtual vehicle; and control, when the virtual object navigates to the position of the first virtual vehicle, the virtual object to leave water and enter the first virtual vehicle; or control, when the first virtual vehicle includes the flying type conveyance, in response to the trigger operation on the vehicle control, the virtual object to jump from a current position on a ground of the virtual scenario to a position of the first virtual vehicle in air and enter an interior of the first virtual vehicle.

In some aspects, the display module 4551 is further configured to display the at least one virtual vehicle and the vehicle control in an inactive state in the virtual scenario, the inactive state being configured for indicating that the virtual object does not have a use permission for the vehicle control; the apparatus further includes a sixth control module, and the sixth control module is configured to control the vehicle control to switch from the inactive state to an active state in response to the virtual object having the use permission for the vehicle control; and the control module 4552 is further configured to control, in response to the trigger operation on the vehicle control in the active state, the virtual object to automatically enter the first virtual vehicle associated with the vehicle control.

In some aspects, the apparatus further includes a sixth display module, and the sixth display module is configured to display an interaction task and task guidance information, the task guidance information being configured for guiding the virtual object to execute the interaction task; display, in response to a task execution operation that is performed on the interaction task and that is triggered based on the task guidance information, a process in which the virtual object executes the interaction task; and control, when the virtual object completes the interaction task, the virtual object to have the use permission for the vehicle control.

An aspect of this disclosure provides a computer program product, the computer program product includes computer-executable instructions or a computer program, and the computer-executable instructions or the computer program are stored in a computer-readable storage medium. A processor of an electronic device reads the computer-executable instructions or the computer program from the computer-readable storage medium, and executes the computer-executable instructions or the computer program, to cause the electronic device to implement the foregoing method for controlling a virtual object according to the aspects of this disclosure.

An aspect of this disclosure provides a computer-readable storage medium, such as a non-transitory computer-readable storage medium, having executable instructions stored therein. When the executable instructions are executed by a processor, the processor is caused to perform the method for controlling a virtual object in the aspects of this disclosure, such as the method for controlling a virtual object shown in FIG. 3.

In some aspects, the computer-readable storage medium may be a memory such as a read-only memory (ROM), a random access memory (RAM), an erasable programmable read-only memory (EPROM), an electrically erasable programmable read-only memory (EEPROM), a flash memory, a magnetic surface memory, an optical disc, or a CD-ROM, or may be various devices including one or any combination of the foregoing memories.

In some aspects, the executable instructions may be written in any form of programming language (including a compiled or interpreted language, or a declarative or procedural language) by using the form of a program, software, a software module, a script or code, and may be deployed in any form, including being deployed as an independent program or being deployed as a module, a component, a subroutine, or another unit suitable for use in a computing environment.

For example, the executable instructions may, but do not necessarily, correspond to a file in a file system, and may be stored in a part of a file that saves another program or other data, for example, be stored in one or more scripts in a hypertext markup language (HTML) file, stored in a file that is specially used for a program in discussion, or stored in the plurality of collaborative files (for example, be stored in files of one or modules, subprograms, or code parts).

For example, the executable instructions may be deployed to be executed on an electronic device, or deployed to be executed on a plurality of electronic devices at the same location, or deployed to be executed on a plurality of electronic devices that are distributed in a plurality of locations and interconnected by using a communication network.

In conclusion, the aspects of this disclosure have the following beneficial effects:

(1) Compared with a solution in which the virtual object needs to be manually moved beside a corresponding vehicle and then enters the vehicle, a solution in which when a trigger operation performed by a user on the vehicle control is received, the virtual object is controlled to automatically enter the first virtual vehicle associated with the vehicle control improves efficiency of the virtual object entering the vehicle. In addition, based on the connecting element configured for indicating the association relationship between the vehicle control and the first virtual vehicle, a virtual vehicle that can be entered based on the vehicle control is clarified, that is, a virtual vehicle to be entered by the virtual object is clarified. This not only improves accuracy of the virtual object entering the vehicle, further improving efficiency of the virtual object entering the vehicle, but also improves human-computer interaction efficiency and utilization of hardware resources of an electronic device.

(2) Visual line guidance is introduced, so that the player sees a vehicle that is currently selected more clearly. The player is given a manner of quickly triggering a vehicle, and a manner of freely selecting to switch a vehicle, which not only improves operation efficiency of the player, increases an automatic vehicle finding function, but also reduces operation costs of the player.

(3) This avoids a case in which in a process of automatically finding paths and entering the vehicle, because the progress cannot be perceived, the player needs to perform subjective determining by using a distance to the vehicle, and when the player mistakenly thinks that the player already reaches the virtual vehicle, the player performs an operation of character displacement and interrupts the process of entering the virtual vehicle. By using the countdown and the distance progress bar, the user may perceive a behavior of interrupting the virtual vehicle by a false touch operation in a current process of moving and finding paths, thereby reducing a behavior of interrupting the virtual vehicle by the accidental touch operation. In addition, the countdown may further be used to make the player perceive an accurate time of entering the virtual vehicle, thereby facilitating the player to perform a next operation.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing descriptions are merely some aspects of this disclosure and are not intended to limit the scope of this disclosure. Any modification, equivalent replacement, or improvement made without departing from the spirit and range of this disclosure shall fall within the scope of this disclosure.

What is claimed is:

1. A method for controlling a virtual object, the method comprising:
outputting for display at least one virtual vehicle and a vehicle entry control element in a virtual scene;
obtaining a first virtual vehicle of the at least one virtual vehicle that is associated with the vehicle entry control element;
outputting for display a first indication of which of the at least one virtual vehicle is the first virtual vehicle that is associated with the vehicle entry control element;
receiving a trigger operation performed on the vehicle entry control element; and
based on the trigger operation performed on the vehicle entry control element when the vehicle entry control element is associated with the first virtual vehicle, controlling the virtual object to automatically enter the first virtual vehicle associated with the vehicle entry control element.

2. The method according to claim 1, wherein the first indication of which of the at least one virtual vehicle is the first virtual vehicle includes display of a connecting element that is configured to indicate the first virtual vehicle.

3. The method according to claim 1, wherein the controlling comprises:
controlling, based on the trigger operation, the virtual object to move toward the first virtual vehicle; and
when the virtual object moves into a sensing region of the first virtual vehicle, controlling the virtual object to enter the first virtual vehicle.

4. The method according to claim 3, further comprising:
outputting for display a distance progress indicator in an associated region of the vehicle entry control element during movement of the virtual object toward the first virtual vehicle,
wherein a progress of the distance progress indicator increases as a distance between the virtual object and the first virtual vehicle decreases, and the distance progress indicator indicates a proportion of the distance traveled by the virtual object relative to a total distance between the virtual object and the first virtual vehicle.

5. The method according to claim 3, further comprising:
outputting for display a countdown in an associated region of the vehicle entry control element during movement of the virtual object toward to the first virtual vehicle,
wherein the countdown indicates a time remaining for the virtual object to move to the first virtual vehicle.

6. The method according to claim 1, wherein the obtaining comprises:
obtaining, based on a distance between the virtual object and the virtual vehicle of the at least one virtual vehicle satisfying a distance condition, the first virtual vehicle.

7. The method according to claim 6, further comprising:
controlling the virtual object in the virtual scene to move based on a movement instruction;
during movement of the virtual object, determining that a second virtual vehicle satisfies the distance condition;
based on the second virtual vehicle satisfying the distance condition, associating the second virtual vehicle with the vehicle entry control element; and
outputting for display a second indication of which of the at least one virtual vehicle is the second virtual vehicle.

8. The method according to claim 6, further comprising:
associating, based on a vehicle switching instruction triggered via the vehicle entry control element, a third virtual vehicle indicated by the vehicle switching instruction with the vehicle entry control element; and
outputting for display a third indication of which of the at least one virtual vehicle is the third virtual vehicle.

9. The method according to claim 8, further comprising:
outputting for display a draggable region corresponding to the vehicle entry control element when the vehicle entry control element is in a draggable state; and
receiving the vehicle switching instruction based on a dragging operation performed on the vehicle entry control element in the draggable region.

10. The method according to claim 9, further comprising:
outputting for display the vehicle entry control element in a fixed state; and
switching the vehicle entry control element from the fixed state to the draggable state based on a state switching instruction performed on the vehicle entry control element.

11. The method according to claim 8, wherein the obtaining comprises:
obtaining the first virtual vehicle based on maximum speed of the first virtual vehicle being greater than or equal to a movement speed threshold.

12. The method according to claim 1, further comprising:
controlling, based on a pressing operation performed on the vehicle entry control element that satisfies a pressing condition, the at least one virtual vehicle to enter a selectable state;
controlling, based on a selection operation performed on a fourth virtual vehicle, the fourth virtual vehicle to enter a selected state;
based on a determining instruction for the selected fourth virtual vehicle, associating the fourth virtual vehicle with the vehicle entry control element; and
outputting for display a fourth indication of which of the at least one virtual vehicle is the fourth virtual vehicle.

13. The method according to claim 9, further comprising:
based on a release of the dragging operation, controlling the virtual object to automatically enter the first virtual vehicle.

14. The method according to claim 1, further comprising:
outputting for display the virtual object outside a sensing region of the at least one virtual vehicle; and
controlling the virtual object to move toward the at least one virtual vehicle based on a movement instruction, wherein
the vehicle entry control element is output for display when the virtual object moves into the sensing region.

15. The method according to claim 1, further comprising:
controlling, based on a vehicle switching instruction, the virtual object to leave the first virtual vehicle and automatically enter a fifth virtual vehicle from the at least one virtual vehicle, the fifth virtual vehicle being different from the first virtual vehicle.

16. The method according to claim 1, wherein
a type of action that is performed by the virtual object to enter the first virtual vehicle is based on a vehicle type of the first virtual vehicle.

17. The method according to claim 1, further comprising:
outputting for display, in the virtual scene, the at least one virtual vehicle and the vehicle entry control element in an inactive state in which the virtual object lacks permission to use the vehicle entry control element; and
switching the vehicle entry control element from the inactive state to an active state based on the virtual object obtaining the permission to use the vehicle entry control element.

18. An information processing apparatus, comprising:
processing circuitry configured to:
output for display at least one virtual vehicle and a vehicle entry control element in a virtual scene;
obtain a first virtual vehicle of the at least one virtual vehicle that is associated with the vehicle entry control element;
output for display a first indication of which of the at least one virtual vehicle is the first virtual vehicle that is associated with the vehicle entry control element;
receive a trigger operation performed on the vehicle entry control element; and
based on the trigger operation performed on the vehicle entry control element when the vehicle entry control element is associated with the first virtual vehicle, control a virtual object to automatically enter the first virtual vehicle associated with the vehicle entry control element.

19. The apparatus according to claim 18, wherein the first indication of which of the at least one virtual vehicle is the first virtual vehicle includes display of a connecting element that is configured to indicate the first virtual vehicle.

20. A non-transitory computer-readable storage medium storing instructions which, when executed by a processor, cause the processor to perform:
outputting for display at least one virtual vehicle and a vehicle entry control element in a virtual scene;
obtaining a first virtual vehicle of the at least one virtual vehicle that is associated with the vehicle entry control element;
outputting for display a first indication of which of the at least one virtual vehicle is the first virtual vehicle that is associated with the vehicle entry control element;
receiving a trigger operation performed on the vehicle entry control element; and
based on the trigger operation performed on the vehicle entry control element when the vehicle entry control element is associated with the first virtual vehicle, controlling a virtual object to automatically enter the first virtual vehicle associated with the vehicle entry control element.
